(19) United States
(12) Patent Application Publication
(10) Pub. No.: US 2008/0055195 A1
(43) Pub. Date: Mar. 6, 2008

(54) Driving method of plasma display panel and plasma display device

(76) Inventors: Keishin Nagaoka, Kawasaki (JP); Yoshikazu Kanazawa, Kawasaki (JP); Naoki Itokawa, Yokohama (JP)

Correspondence Address: MCDERMOTT WILL & EMERY LLP, 600 13TH STREET, N.W., WASHINGTON, DC, 20005-3096, US

(21) Appl. No.: 11/645,010

(22) Filed: Dec. 26, 2006

(30) Foreign Application Priority Data
Aug. 30, 2006 (JP) JP2006-234345

(51) Int. Cl. G09G 3/10

(52) U.S. Cl. 345/41

(57) ABSTRACT

A technique which relates to discharge in sustain operation of a PDP device and a driving waveform thereof, and which can improve luminous efficiency to achieve stability while reducing a possibility of failure of discharge is provided. In a generating operation of a sustain pulse in a sustain pulse generating circuit, after LU-ON (t1 to t2), a voltage applied on electrodes is raised up to a sufficiently-high voltage, namely, a sustain voltage according to an ON state of a CU circuit (t2 to t3), and discharge is started, CU is once turned OFF (t3), then a first discharge peak is formed (t11). Thereafter, CU is turned ON again before discharge is converged (t12) to raise a voltage value and form a second discharge peak (t14). Since a voltage Vi to start discharge is sufficiently high, a possibility of discharge failure is suppressed, and an effect of improvement in luminous efficiency is not ruined.

### CROSS-REFERENCE TO RELATED APPLICATION

The present application claims priority from Japanese Patent Application No. JP 2006-234345 filed on Aug. 30, 2006, the content of which is hereby incorporated by reference into this application.

### TECHNICAL FIELD OF THE INVENTION

The present invention relates to a technique for a plasma display device (PDP device) provided with a plasma display panel (PDP). More particularly, the present invention relates to discharge in the sustain operation of the subfield (which is also called sub-frame) drive control or the like and a driving waveform thereof.

### BACKGROUND OF THE INVENTION

In a conventional PDP device, one of technical problems is improvement of luminous efficiency [lm/W] for achieving low power consumption and high luminance. One of means for improvement of luminance efficiency is a technique described in Japanese Patent Publication No. 3242096 (Patent Document 1). This realizes high efficiency by separating a peak of the discharge optical emission into two in the sustained discharge in sustain operation of the subfield drive control.

In FIG. 7, as a conventional first technique, an operation example of basic sustained discharge is shown. In this operation, with respect to a single driving waveform (Px/Py), a discharge optical emission (E) thereto basically shows an inverted V shape, that is, one discharge peak (511) is basically obtained (timing t4). An applied voltage value with the driving waveform (Px/Py) is from −Vs (negative sustain voltage) to Vs (positive sustain voltage).

In FIG. 8, as a conventional second technique, a configuration is shown where discharge is started using an energy recovery circuit to separate a peak of discharge optical emission of sustained discharge into two like the technique described in the Patent Document 1, which is different from the first technique. In this operation, with respect to a single driving waveform (Px/Py), a discharge emission (E) thereto is separated into two discharge peaks (521, 522) (timings t11 and t14).

In FIG. 9, as a conventional third technique, an operation example of another sustained discharge is shown. In this operation, a configuration including two driving waveforms instead of a single driving waveform is utilized. This technique is described in Japanese Patent Application Laid-Open Publication No. 9-319329 (Patent Document 2).

### SUMMARY OF THE INVENTION

In the conventional sustain operation of PDP device, a value of a voltage applied on electrodes (voltage Vi to start discharge; firing voltage) when sustained discharge is started (conducted) is a very important factor from a viewpoint that discharge thereafter is performed uniformly and stably in all cells.

In the first technique (basic configuration example) in FIG. 7, after the voltage applied on electrodes (Px/Py) is once raised up to a first voltage (V1) by an LU circuit, the voltage Vi is raised up so as to become Vi≈Vs by a CU circuit to start sustained discharge (timing t3).

In the second technique in FIG. 8, since sustained discharge is started by the LU circuit, discharge is started at the voltage (V2) which is lower than Vs as the voltage Vi to start discharge (timing t3).

Therefore, in the second technique to achieve higher efficiency, due to that the voltage to start discharge is low, depending on panel characteristics (a structure and a driving system) and cell characteristics (cell uniformity) or the like of a PDP, particularly in a so-called ALIS system, there is a problem that a possibility that discharge will fail becomes higher than that in the first technique.

The present invention is made in view of such a problem as described above, and an object thereof is to provide a technique which relates to discharge in sustain operation of a PDP device and a driving waveform thereof, and which can improve luminous efficiency while reducing a possibility of discharge failure to achieve stability.

The typical ones of the inventions disclosed in this application will be briefly described as follows. In order to achieve the object, the present invention is a technique for driving a PDP provided with at least two kinds of electrodes (X and Y electrodes) to conduct sustained discharge, and characterized in that the following technical means is provided. A PDP device applies a driving waveform to the electrodes of the PDP from a circuit unit such as a driving circuit to ignite discharge between the electrodes.

In operation for igniting discharge by applying a single driving waveform (discharge waveform) to a target electrode of the PDP, the method of driving a PDP of the present invention achieves a higher voltage of a voltage applied to electrodes (a voltage Vi to start discharge) at a discharge start point (at a timing of starting discharge optical emission). That is, in the method of driving a PDP and the PDP device, especially, the second technique for improving light emission efficiency, namely, a configuration of separating a discharge peak (showing two ups and downs) in a single driving waveform is applied to the basic configuration (the first technique), and simultaneously a configuration of making the voltage Vi to start discharge higher than that in the conventional second technique, for example, as near as possible to Vs is applied.

The operation of igniting discharge according to application of a single driving waveform is a sustain operation of igniting sustained discharge between X-Y electrodes predetermined times by repeatedly applying single waveforms (sustain pulses) which make a pair with respect to the X and Y electrodes, for example. The arbitrary single waveform and operation according thereto are not limited to a waveform (sustain pulse) for sustained discharge and sustain operation according thereto.

The method of driving a PDP is characterized in that, in generation (output) of the arbitrary single driving waveform, operation to turn on a switch element for controlling operation of fixing (clamping) a voltage to the voltage (Vi) of starting discharge is performed at least twice. In other words, operation for turning-ON (first time) from an off state is first performed, next operation for turning-OFF is performed, and operation for turning-ON (second time) is performed again. That is, in the operation, for example, when raising a driving waveform for sustained discharge is performed, after a pre-CU-ON is performed in an LU-ON state, a main-CU-ON is performed. The same is applied when discharge is started by falling. The term “LU” means rising due to LC resonance, and the term “CU” means rising due to voltage clamping.

Specifically, in the operation, for example, the voltage Vi is raised from the LU-ON state so as to be Vi≈Vs in a relatively-short CU-ON state according to a first CU-ON, next a first discharge peak is formed in a short CU-OFF state, and a second discharge peak is next formed in a relatively-long CU-ON state according to a second CU-ON before discharge is converged.

In the method of driving a PDP, specifically, operation is performed in the following processes (P0 to P5), for example. In the PDP device which performs the driving method of the present invention, a circuit of generating and outputting a sustain pulse which is a single waveform to the X and Y electrodes, for example, in a sustain operation includes an LU circuit, a CU circuit, and the like. The LU circuit includes a first switch element for controlling rising of a waveform due to LC resonance operation in the energy recovery circuit. The CU circuit includes a second switch element for controlling rising of a waveform due to voltage clamping to Vs which is connected to a Vs power supply and a panel capacity (Cc).

(P0) First, the LU circuit (the first switch element) is turned ON (t1). Thereby, a voltage value of a waveform starts rising due to the LC resonance.

(P1) Next, the first ON of the CU circuit (the second switch element) is performed (t2). Thereby, the voltage value of the waveform is raised from a voltage level (V1) which has been raised by the LC resonance to Vs or a value as near as possible to Vs as the voltage Vi to start discharge (t3).

(P2) Thereafter, from the state of Vi≈Vs, the CU circuit (the second switch element) is once turned OFF (t3). Thereby, switching to discharge in the ON state of the LU circuit (the first switch element) is performed.

(P3) By the switching, discharge contraction due to voltage drop occurs, which forms a first discharge peak (t11).

(P4) Before discharge is completely converged, the CU circuit (the second switch element) is turned ON again (second time) (t12).

(P5) In the ON state of the CU circuit (the second switch element), discharge is restored. The voltage value of the waveform rises up to about Vs (t13). Thereby, a second discharge peak is formed (t14).

In the above processes, just after the voltage level Vi of the waveform is raised up to about Vs in the CU circuit, discharge is started. Therefore, it is realized to suppress a possibility of failure of discharge at the same level as the first technique. Besides, a main part of discharge of the first discharge peak is performed in the LU circuit (in an ON state) like the second technique. Therefore, separation of the discharge peak in a single driving waveform, and an effect of luminous efficiency improvement according thereto are equivalent to that in the second technique.

The effects obtained by typical aspects of the present invention will be briefly described below. According to the present invention, in relation to discharge in sustain operation of the PDP device and a driving waveform thereof, the possibility of failure of discharge is reduced to achieve stability, and luminous efficiency can be improved. In particular, when a configuration of separation of a discharge peak (the second technique) is adopted, the possibility of failure of discharge can be suppressed to a level equivalent to that of the first technique without ruining the effect of luminous efficiency improvement.

### BRIEF DESCRIPTIONS OF THE DRAWINGS

FIG. 1 is a diagram showing a block configuration of a whole PDP device in an embodiment of the present invention;

FIG. 2 is a view showing an example of a panel structure of a PDP in the PDP device of the embodiment of the present invention;

FIG. 3 is a diagram showing a configuration of a field and a subfield in the PDP device of the embodiment of the present invention;

FIG. 4 is a diagram showing a configuration example of a driving waveform of the PDP in the PDP device of the embodiment of the present invention;

FIG. 5 is a diagram showing a configuration of a sustain pulse generating circuit in the PDP device of the embodiment of the present invention;

FIG. 6 is a diagram showing a sustained discharge optical emission, a sustain pulse (rising part), and a switch control operation as sustain operation in the PDP device of the embodiment of the present invention;

FIG. 7 is a diagram showing a sustained discharge optical emission, a sustain pulse (rising part), and switch control operation in a conventional first technique;

FIG. 8 is a diagram showing a sustained discharge optical emission, a sustain pulse (rising part), and a switch control operation in a conventional second technique; and

FIG. 9 is a diagram showing a sustain pulse and a switch control operation in a conventional third technique.

### DESCRIPTIONS OF THE PREFERRED EMBODIMENTS

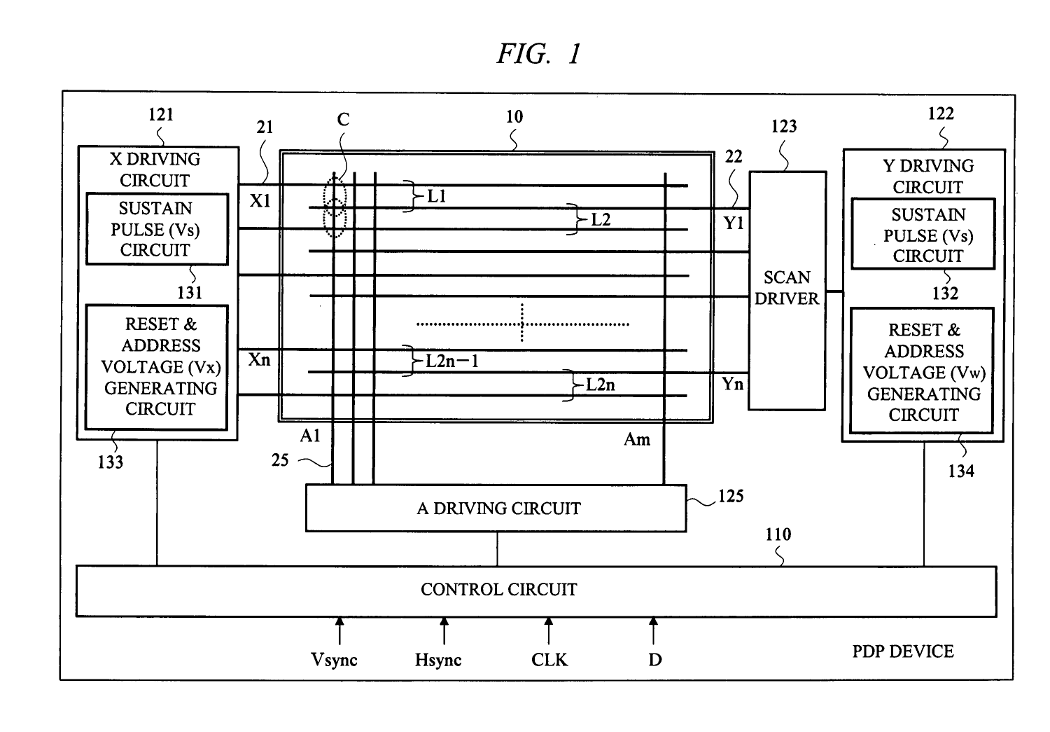

Hereinafter, an embodiment of the present invention will be described in detail with reference to the accompanying drawings (FIG. 1 to FIG. 9). Note that components having the same function are denoted by the same reference symbols throughout the drawings for describing the embodiment, and the repetitive description thereof will be omitted.

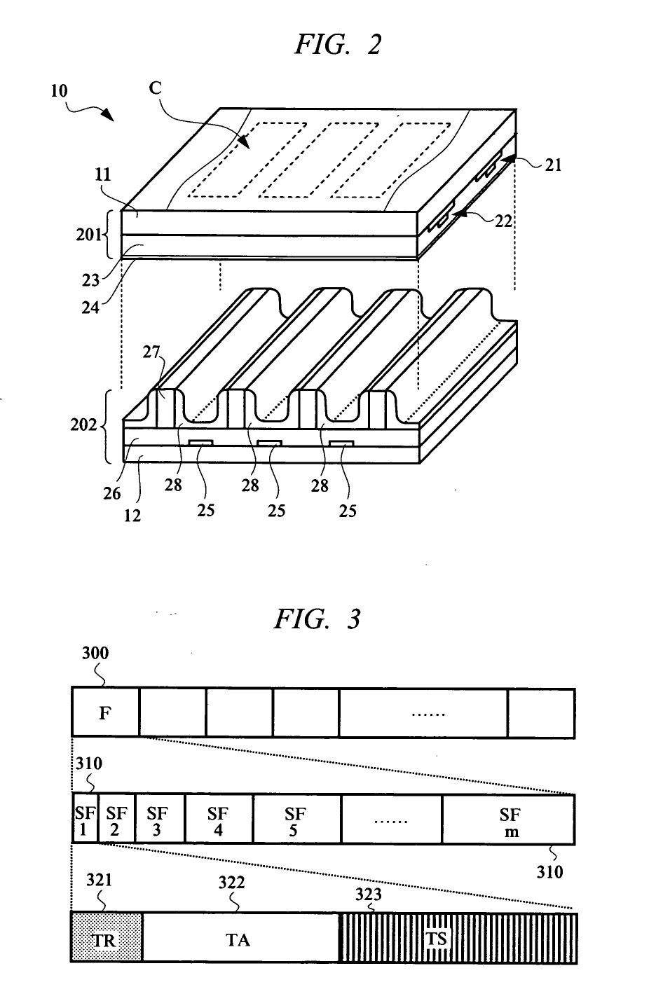

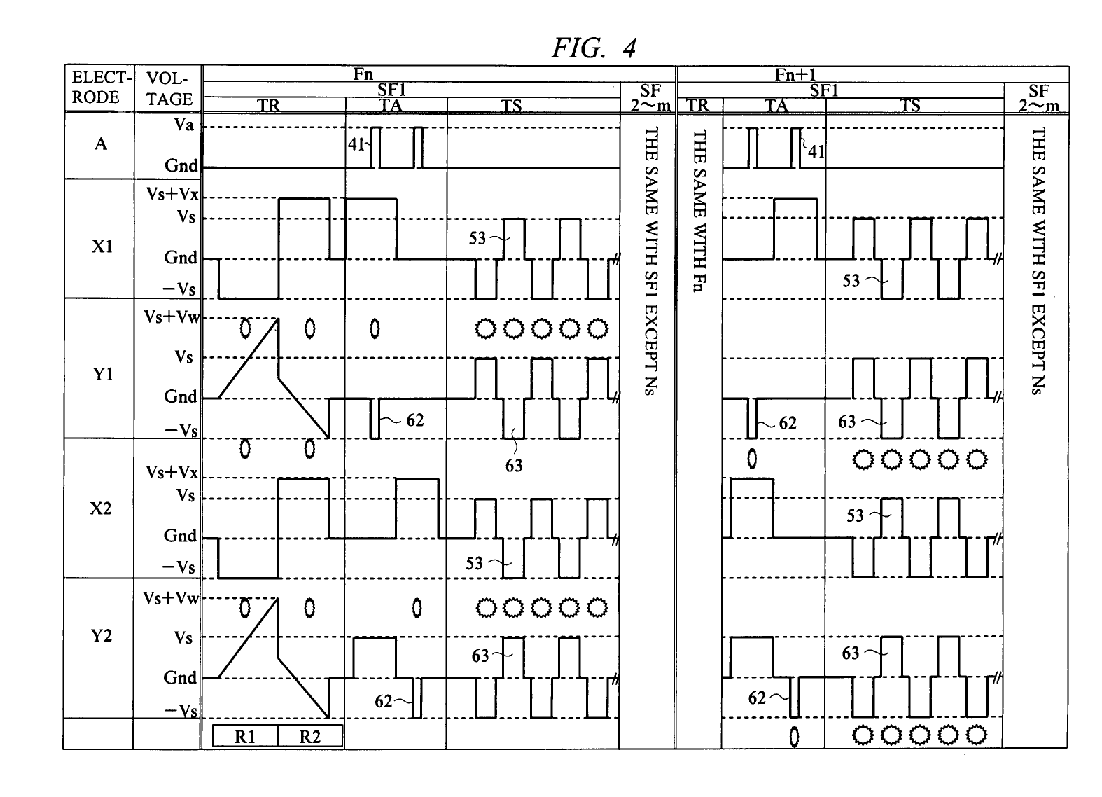

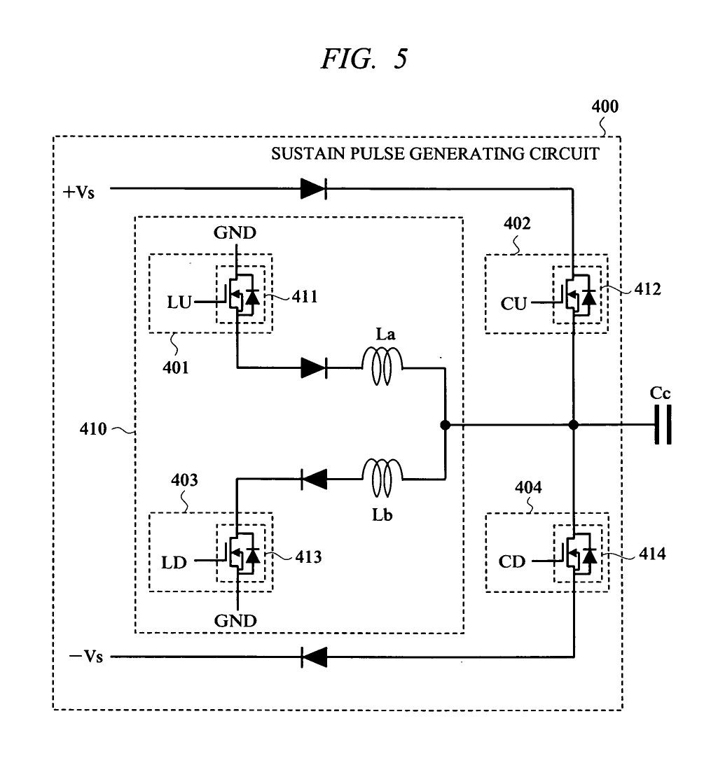

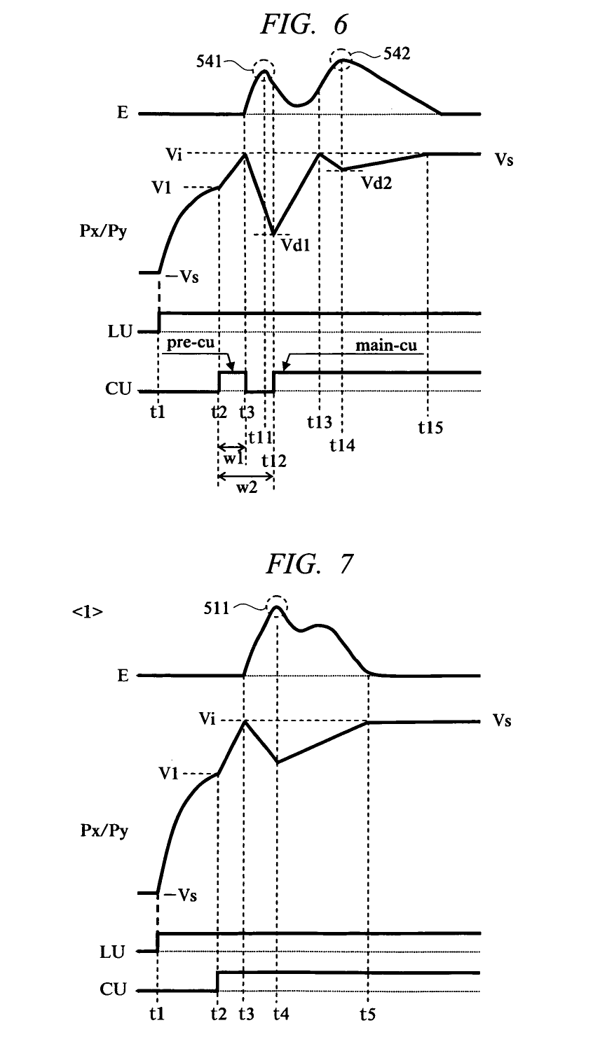

In the present embodiment, FIG. 1 shows a whole PDP device, FIG. 2 shows a structure example of a PDP, FIG. 3 shows a field and a subfield (abbreviated to SF), FIG. 4 shows an example of a driving waveform of the field and the subfield, FIG. 5 shows a sustain pulse generating circuit, and FIG. 6 shows a configuration of sustain operation. FIG. 7 to FIG. 9 show configurations of sustain operations of respective conventional techniques (first to third techniques) in order to give a simplified explanation in comparison with the embodiment.

Basic configurations of a PDP device and a driving method of the embodiment will be explained below with reference to FIG. 1 to FIG. 4. The present PDP device and the driving method is configured with the ALIS system which is known in the art.

<PDP.device>

In FIG. 1, the present PDP device (PDP module) is provided with a PDP 10 and a circuit section for driving and controlling the PDP 10. The PDP module is configured such that the PDP 10 is attached and retained on a not shown chassis portion, the circuit section is composed of an IC and the like, and the PDP 10 and the circuit portion are electrically connected. The PDP module is further contained in an external casing to configure the PDP device (product set).

The circuit section has a control circuit 110 and respective driving circuits (drivers). The driving circuits includes an X driving circuit 121, a Y driving circuit 122, a scan driver 123, and an A (address) driving circuit 125. Incidentally, the Y driving circuit 122 is for common drive of a Y electrode 22 group, and the scan driver 123 is for individual driving of the Y electrode 22 group, but they may be thought as one driving circuit for driving Y electrode.

A display cell (C) of the PDP 10 is composed of an intersection of a row (lines: L) which is a pair of an X electrode (sustain electrode) 21 and a Y electrode (scan electrode) 22 which are disposed in parallel with a column which is an A (address) electrode 25 disposed perpendicular to the X electrode 21 and the Y electrode 22. The respective electrodes are connected to driving circuits corresponding thereto to be driven by driving waveforms from the driving circuits. The respective driving circuits are connected to the control circuit 110 to be controlled by a control signal.

The control circuit 110 controls the whole PDP device including the respective driving circuits. The control circuit 110 are inputted with Vsync (vertical synchronizing signal), Hsync (horizontal synchronizing signal), CLK (clock), D (display data), and the like. The control circuit 110 generates control signals, display data (field and SF data) or the like for driving the PDP 10 based on display data (D), and outputs them to the respective driving circuits. A not shown power supply circuit supplies power to each circuit such as the control circuit 110.

The X driving circuit 121 includes a sustain pulse (Vs) circuit 131 and a reset and address voltage (Vx) generating circuit 133. The Y driving circuit 122 includes a sustain pulse (Vs) circuit 132 and a reset and address voltage (Vw) generating circuit 134. The sustain pulse circuit 131 generates a sustain pulse (Px) based on the sustain voltage (Vs), which is applied to the X electrode 21. The sustain pulse circuit 132 generates a sustain pulse (Py) based on the sustain voltage (Vs), which is applied to the Y-electrode 22. The reset and address voltage (Vx) generating circuit 133 generates a reset and address voltage (Vx) which is applied to the X-electrode 21. The reset and address voltage (Vw) generating circuit 134 generates a reset and address voltage (Vw) which is applied to the Y-electrode 22.

In the ALIS system, a display area of the PDP 10 has odd lines (L1, L3, . . . , L2n−1) and even lines (L2, L4, . . . , L2n), as display rows (lines: L) obtained by adjacent pairs in n X-electrodes 21 and n Y-electrodes. As display columns, the display area of the PDP 10 has repetition of R, G and B columns due to m A-electrodes 25.

<PDP>

Next, in FIG. 2, an example of a panel structure (AC type surface discharge, three electrodes, and stripe rib configuration) of the PDP 10 will be explained. One portion corresponding to a pixel is shown. The PDP 10 is configured such that a structural body (front portion 201) of a front substrate 11 side and a structural body (rear portion 202) of a rear substrate 12 side, which are mainly made of glass, are combined so as to be opposed to each other, peripheral portions thereof are sealed, and discharge gas such as Ne—Xe is charged in a space defined therebetween.

In the front portion 201, a plurality of X electrodes 21 and a plurality of Y electrodes 22 which are electrodes (display electrodes) for performing sustained discharge or the like are formed on the front substrate 11 such that they are extended in parallel in a first direction (lateral direction) at fixed intervals and alternately repeated in a second direction (vertical direction). These display electrode (21, 22) groups are covered with a first dielectric layer 23, and further a surface of the first dielectric layer 23 extending toward a discharge space is covered with a protective layer 24 made from MgO or the like. The display electrodes (21, 22) are each composed of, for example, a linear bus electrode made from metal and a transparent electrode which forms a discharge gap between adjacent electrodes electrically connected to the bus electrodes.

In the rear portion 201, a plurality of address electrodes 25 are formed on the rear substrate 12 so as to extend in parallel in the second direction. Further the address electrode 25 group is covered with a second dielectric layer 26. Partition walls (vertical ribs) 27 extending in the second direction are formed on both sides of the address electrode 25 to partition the display area in a column direction. Further, an upper face of the second dielectric layer 26 and sidesurfaces of the partition wall 27 on the address electrode 25 are applied with phosphors 28 corresponding to respective colors, which are excited by an ultraviolet ray to generate visible lights of red (R), green (G) and blue (B), at every column in distinction from one another. A pixel is composed of a set of R, G and B cells (C). There are various structures of PDP according to a drive system or the like.

<Field and Driving Waveform>

Next, a configuration example of a field in drive control of the PDP 10 and a basic driving waveform thereof will be explained with reference FIG. 3 and FIG. 4. The drive system is a general address display separation system.

In FIG. 3, one field (which is also called “frame”) 300 which is an image display unit corresponding to a display area (screen) and a time period of the PDP 10 is displayed at 1/60 second, for example. The field (F) 300 is composed of a plurality (m) of SFs (subfields) 310 which are temporally divided for gray scale (multiple gray scale). For example, the field 300 is composed of ten SFs 310 of SF 1 to SF 10. Each SF 310 is composed of a time period of reset (TR) 321, a time period of address (TA) 322 which is next to the time period of reset 321, and a time period of sustain (TS) 323 which is next to the time period of address 322. Each SF 310 of the field 300 is imparted with weighting based on a length of the TS 323, namely, the number of sustained discharges (sustain number) Ns, and gray scale of the cell (pixel) is displayed by a combination of ON/OFF of lighting of each SF 310 of the field 300.

In FIG. 4 is shown outline of each driving waveform applied to respective electrodes, namely, the A-electrode 25, the X-electrode 21 and the Y-electrode 22 (for example, X1, Y1, X2 and Y2 corresponding to three lines L1 to L3) in each SF 310 (SF1 to SFm) of a field 300 (Fn) and a next field 300 (Fn+1).

Specific operation is as follows: Operation due to a driving waveform in FIG. 4 is started by inputting Vsync externally into the control circuit 110.

First, respective cells in the field 300 retain different amounts of wall charge, depending on a display state of a precedent field 300. Therefore, all the cells are put into approximately-homogenous state at a first TR 321 of the SF 310 to prepare for the next operation of TA 322. TR 321 is roughly composed of two time periods corresponding to two waveforms of a write reset waveform (R1) and a compensation reset waveform (R2). The write reset waveform (R1) is a waveform for generating (accumulating) a large amount of wall charge to all the cells. The compensation reset waveform (R2) is a waveform for removing unnecessary charge from a large amount of wall charge written by R1 to adjust all the cells to approximately-homogenous wall charge states, in order to arrange a charge amount which allows address discharge according to display data. For example, fine discharge is generated in a cell according to application of reset waveforms (R1, R2) including a ramp to the display electrodes (21, 22).

In the next TA 322, based on the display data (SF data), address discharge is performed only at a cell to be lightened which is selected from the cell group of the SF 310 to accumulate wall charge enough to perform sustained discharge. Address discharge is generated at the selected cell by applying a scan pulse 62 (voltage: −Vs) to the Y-electrode 22 of an arbitrarily-selected line, applying a predetermined voltage (Vs+Vx) to the X-electrode 21, and at a timing corresponding thereto, applying an address pulse 41 (voltage: Va) to the selected address electrode 25, based on the display data (SF data).

In the next TS 323, a pair of sustain pulses (53, 63) whose polarities are alternately reversed are repeatedly applied between the display electrodes (21, 22) for the number of sustains (Ns) according to the weighting of the SF 310 simultaneously at all the cells. Thereby, sustained discharge (indicated by a circle) is generated only at the selected cells which retain a lot of charge at address discharge of the prior TA 322. Owing to the sustained discharge optical emission, a user can recognize it as luminance.

In a second SF 310 and subsequent thereto (SF2 to SFm), operation is the same as SF1 except for the number of sustains (Ns). The TR 321 is the same in each field 300 and the SF 310. In the TA 322 the operation corresponds to a line to be driven.

In the ALIS system, a waveform of the next field 300 (Fn+1) next to a field 300 (Fn) is partially different from a waveform of the precedent field 300 (Fn). Specifically, driving waveforms applied to, for example, X1 and X2 which are the X electrodes 21 are exchanged. That is, a drive (interlace drive) which alternately switches an odd number line (slit) to be driven and an even number line (slit) to be driven for each field 300 is used. Thereby, in the field 300 (Fn), for example, an odd number line such as L1 defined by X1−Y1 is driven to display (sustained discharge optical emission of the selected cell), and in the next field 300 (Fn+1), a line which is not driven to display in the precedent field 300 (Fn), for example, an even number line such as L2 defined by Y1−X2 is driven to display. Such the ALIS system as described above has a great advantage that a scale and an address time of the driving circuit become about a half of a conventional scale and a conventional address time.

<First and Second Methods>

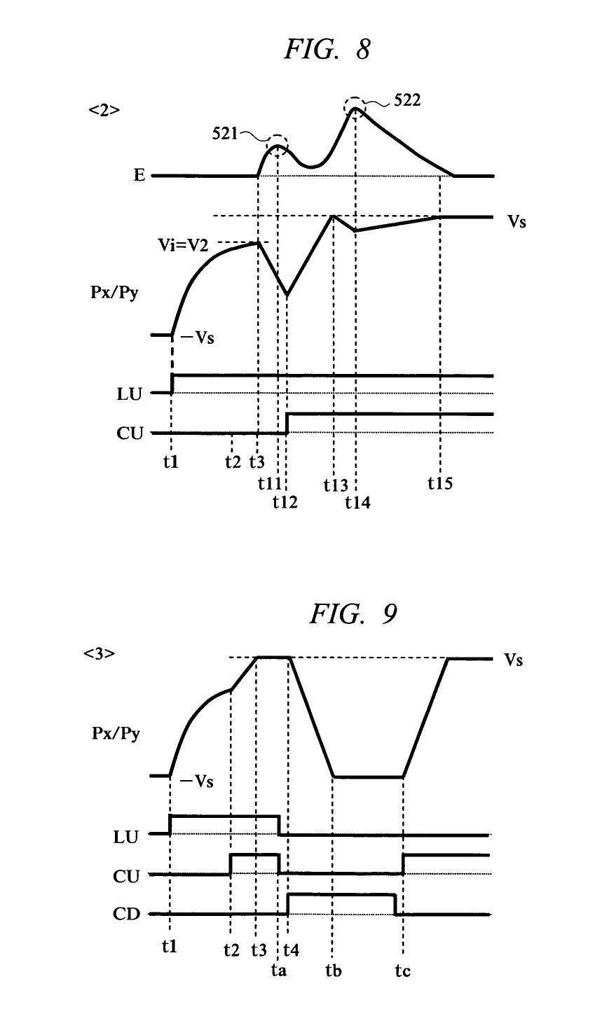

Next, for comparison with the present embodiment, one example of sustain operation and sustained discharge optical emission according to the conventional first method and the conventional second method will be explained with reference to FIG. 5, FIG. 7, FIG. 8, and the like. FIG. 5 shows a configuration example of a basic sustained pulse generating circuit 400 for generating and outputting a sustain pulse. Incidentally, the configuration of the sustain pulse generating circuit in FIG. 5 is basically the same configuration as the present embodiment, and the conventional first and second methods, but control of the sustain pulse generating circuit is mainly different from each other. FIG. 7 shows a rising portion of a basic sustain pulse (driving waveform for generating sustained discharge) in sustain operation based on the first technique without using the second technique (technique described in the Patent Document 1). FIG. 8 similarly shows a rising portion of a sustain pulse in sustain operation based on the second technique applied with the technique described in the Patent Document 1 with respect to the basic configuration (first technique) in FIG. 7.

First, in the sustain pulse generating circuit 400 in FIG. 5, when an LU circuit (first switch element) 401 is turned ON, a current flows from GND (ground) via a coil La. At this time, due to LC resonance of the coil La and a panel capacity Cc, a rising waveform becomes a curve whose slope changes to be gentle with time like a timing from t1 to t2 in FIG. 7.

Next, when the CU circuit 402 is turned ON after a fixed time period of the LU circuit 401 being turned ON elapses (t2), the panel capacity Cc is directly connected to a Vs power supply, so that a voltage rises up to Vs at once like in a period from t2 to t3 in FIG. 7. The voltage of starting discharge is Vi≈Vs. Hereupon, discharge is performed, and a discharge optical emission waveform (E) at this time roughly becomes a mass (t3 to t5). The discharge optical emission waveform (E) drops a little after the discharge starts (t3) reaching one discharge peak 511 (t4), and converged along with the voltage becomes constant to Vs (t5). Falling of the waveform is performed in order of a CD circuit 404 then an LD circuit 403, but the concept is the same as the case of rising, so that explanation thereof is omitted.

Next, in the second technique in FIG. 8 with respect to the first technique in FIG. 7, a difference in circuit control between these techniques lies in a time difference between LU-ON and CU-ON, that is, the time difference is large in the second technique in FIG. 8 as compared with the first technique in FIG. 7. Therefore, a large difference in discharge phenomenon is caused. Specifically, the discharge optical emission waveform (E) of the first technique in FIG. 7 forms one mass approximately, but the discharge optical emission waveform (E) of the second technique in FIG. 8 has two separated discharge peaks (521, 522).

The two discharge peaks (521, 522) are generated specifically in the following processes (P0 to P4).

(P0) By turning ON the LU circuit 401 (t1), a voltage value of a waveform (Px/Py) is raised along a curve whose slope becomes gentle gradually due to LC resonance.

(P1) In an ON state of the LU circuit 401, discharge is started at a predetermined voltage Vi=V2 (t3). A time difference is (t3−t1)>(t2−t1). Additionally, V2<Vs.

(P2) Discharge contraction due to voltage drop occurs just after the discharge (E) is started, and a first discharge peak (521) is formed (t11).

(P3) Before the discharge (E) is completely converged, the CU circuit 402 is turned ON (t12).

(P4) In an ON state of the CU circuit 402, the discharge (E) is restored. That is, an intensity of the discharge (E) rises again. A voltage level of the waveform (Px/Py) rises up to Vs (t13), and, thereafter, the voltage drops a little and discharge of a second discharge peak (522) is formed (t14). Thereafter, along with the voltage level becomes constant at Vs, the discharge (E) is converged (t15).

In this manner, it is experimentally validated that, due to two ups and downs of the discharge peaks (521, 522) in a single driving waveform (Px/Py), although luminance (single luminance) per sustained discharge lowers, a current for optical emission is further reduced over the lowering, which results in improvement of luminous efficiency.

In the first technique in FIG. 7, since the voltage Vi to start discharge is Vi≈Vs, it is advantageous that a possibility of failure of discharge is low. In the second technique in FIG. 8, luminous efficiency can be improved, but a disadvantage arises that there is a possibility of discharge failure according to a panel characteristic or the like.

<Sustain Operation>

Next, sustain operation and the like which is a features of the PDP device according to the first embodiment will be explained with reference to FIG. 5, FIG. 6, and the like.

First, in FIG. 5, a configuration of the sustain pulse generating circuit 400 will be explained. The sustain pulse generating circuit 400 corresponds to the sustain pulse (Vs) circuits 131, 132 in the X driving circuit 121 and the Y driving circuit 122 in FIG. 1. The sustain pulse generating circuit 400 is connected to every panel capacity Cc corresponding to the cell of the PDP 10. The sustain pulse generating circuit 400 is configured so as to contain or connect power supplies of positive and negative sustain voltages (Vs, −Vs) and a energy recovery circuit 410. The sustain pulse generating circuit 400 has an LU (LC resonance up) circuit 401 including a first switch element 411, a CU (clamp up) circuit 402 including a second switch element 412, an LD (LC resonance down) circuit 403 including a third switch element, and a CD (clamp down) circuit 404 including a fourth switch element.

The LU circuit 401 and the LD circuit 403 are circuits for controlling LC resonance operation in the energy recovery circuit 410. The CU circuit 402 and the CD circuit 404 are circuits for controlling voltage clamp operation which is connected to the power supplies of positive and negative sustain voltages (Vs, −Vs) and the panel capacity Cc. The LU circuit 401 and the CU circuit 402 relate to rising of a driving waveform, and the LD circuit 403 and the CD circuit 404 relates to falling of a driving waveform. The LU resonance is resonance of coils La, Lb and the panel capacity Cc.

The first to fourth switch elements 411 to 414 are each composed of an FET (field effect transistor) and the like. For example, the term “LU” of the LU circuit 401 means control input of ON/OFF of the first switch element 411, and the same applied to the other switch elements.

In the FET of the first switch element 411 of the LU circuit 401, its drain is connected to a GND side, its source is connected to the coil L1 side via a diode, and its gate serves for control input “LU”. The control input “LU” is a signal of LU ON/OFF which is supplied from a logic circuit, a pre-driver or the like which are not shown. By the control input “LU”, a state of the FET which is the first switch element 411 is short-circuited and connected (LU-ON) or opened (LU-OFF). Similarly, the LD circuit 403 is connected to the GND and the coil Lb, and LD-ON/OFF is controlled by the control input “LD”.

In the FET which is the second switch element of the CU circuit 402, the drain is connected to the Vs (positive sustain voltage) power supply side via the diode, the source is connected to the panel capacity Cc side, and the gate serves for a control input “CU”. The control input “CU” is a signal of CU-ON/OFF which is supplied from the logic circuit, the pre-driver or the like which are not shown. Similarly, the CU circuit 404 is connected to the −Vs (negative sustain voltage) power supply and the panel capacity Cc, and CD-ON/OFF is controlled by the control input “CD”.

Next, in FIG. 6, the sustain operation in the present embodiment will be explained. FIG. 6 shows a discharge optical emission (E), a driving waveform (Px/Py), and switch controls (LU, CU). In the sustain pulse generating circuit 400 in FIG. 5, the driving waveform (Px/Py) in FIG. 6 is generated and outputted to be applied to display electrodes (21, 22) according to switch control operation such as LU or CU. Px/Py shows a rising portion of the sustain pulses (53, 63) applied to the X electrode 21 and the Y electrode 22. LU and CU are states of ON(H)/OFF(L) of each switch element of the LU circuit 401 and the CU circuit 402. E shows discharge optical emission due to Px/Py and intensity thereof.

The present embodiment is characterized in that CU-ON with a single driving waveform shown by Px/Py is applied twice in switch control operation (a time period of t2 to t3 and a time period after t12). In other words, as switch control operation, an LU-ON state is once turned OFF in a short time after CU-ON, and CU is turned ON again in a short time thereafter. Here, the first CU-ON state is called pre-cu, and the second CU-ON state is called main-cu. The sustain operation is the following processes (P0 to P5) specifically.

(P0) First, the LU circuit 401 is turned ON (timing t1). Thereby, a voltage level of the waveform (Px/Py) is raised due to LC resonance (t1 to t2). The waveform is a curve whose slope becomes gentle gradually.

(P1) Next, in the LU-ON state, first turning-ON is performed at the CU circuit 402 (t2). Thereby, as the pre-cu operation, a voltage value of the waveform (Px/Py) is raised, from a level (V1) raised due to the LU resonance, up to the voltage Vi to start discharge Vi≈Vs or a value as near as possible to Vs (t2 to t3).

The timing (t2) to apply (ON) pre-CU is equivalent to that in the first technique in FIG. 5. An interval (t1 to t2) between LU-ON and pre-cu-ON changes depending on a constant of the coil (La), but it is approximately from 200 ns to 400 ns. Since the waveform (Px/Py) is raised up to about Vs due to pre-cu-ON (t2), the discharge (E) can be started at Vi≈Vs (t3).

(P2) Next, at the Vi≈Vs (t3), the CU circuit 402 is once turned OFF (pre-cu-OFF). Thereby, the state is switched to a state of discharge due to an ON state of the LU circuit 401.

It is preferable that a pre-cu width w1 is in a range of about 40 ns or more to 200 ns or less. This is because, when the width w1 is too short (less than 40 ns), the pre-driver of the FET (the second switch element 412) is not turned ON or the voltage is not sufficiently raised, and when the width w1 is too long (more than 200 ns), discharge due to the ON state of the LU circuit 401 can not be performed sufficiently.

(P3) Next, just after the Vi≈Vs (t3), discharge contraction due to voltage drop occurs and the first discharge peak 541 is generated (t11). The voltage largely drops due to discharge at the LU circuit 401 (for example, voltage level Vd1 at t12), thereby the discharge (E) is once contracted and the first discharge peak 541 is formed. This is the same as the known example (the second technique).

(P4) Next, before the discharge (E) is completely converged, CU application (ON) of the CU circuit 402 is performed again (t12). That is, at a timing (t12) just after the first discharge peak 541 (t11), main-cu is turned ON.

(P5) Next, in an ON state of the CU circuit 402 (and an ON state of the LU circuit 401), the discharge (E) is restored (t12 to t14). The voltage value of the waveform (Px/Py) rises up to about Vs (t13), and thereafter the voltage drops a little due to discharge (for example, voltage value Vd2 at t14) and the discharge (E) of the second discharge peak 524 is generated (t14).

The timing (t12) of the second application of CU (main-cu-ON) is approximately the same as that of the first CU-ON in the second technique in FIG. 8.

A delay time (t2 to t12) elapsing from pre-cu-ON to main-cu-ON is called main-cu-delay. It is preferable that a width w2 of the main-cu-delay is in a range of about 100 ns or more to 400 ns or less. This is because, when the width w2 is too short, a discharge time due to the LU circuit 401 is insufficient, and when the width w2 is too long, discharge of the first discharge peak 541 is converged, so that discharge of the second discharge peak 542 is not performed. Through the above process, the sustain pulses (53, 63) which generate sustained discharge which has two discharge peaks (541, 542) and satisfies Vi≈Vs is generated.

Note that, in the present embodiment, as for two kinds of electrodes (the X-electrode 21, the Y-electrode 22) which are mainly subjected to sustained discharge, a case that discharge is started when one electrode is displaced from −Vs potential to +Vs potential is described as shown in FIG. 6. However, the present invention is not limited to this case, and the same effect can also be obtained by a similar control in a case that discharge is started when one electrode is displaced from +Vs potential to −Vs potential, or a case that discharge is started when one electrode is displaced from ±Vs to GND.

<Difference from the Third Technique>

Next, differences between the method of the present embodiment and the conventional third technique will be explained with reference to FIG. 9. In FIG. 9, in a switch control operation of the sustain pulse generating circuit 400 in the third technique similar to that described above, CU is in the first ON state in a time period of t2 to ta, CU is in an OFF state in a time period of ta to tc, and CU is in the second ON state in a time period after tc. Both LU and CU are turned OFF at ta and CD is turned ON at t4. Thereby, a pulse is fallen, and one pulse is formed within a time period of t1 to tb. Thereafter, due to CU-ON at tc, a second pulse is raised.

The third technique in FIG. 9 is similar to the method of the embodiment shown in FIG. 6, in that CU-ON is performed twice in a relatively-short interval in generation of a sustain pulse, but completely different in the following point.

The both are different in the number of pulses (driving waveform). In the third technique, as shown in FIG. 9, a voltage value of a pulse is raised up to Vs according to a CU-ON state (t2 to ta), and thereafter CU is turned ON (tc) again in a short time after a pulse is once fallen by CD-ON (t4). This is a set of two pulses because a slender pulse (t1 to tb) is added before a normal pulse (after tc), as described in the Patent Document 2. Therefore, the set of two pulses is completely different from a single pulse (including t1 to t15) as shown in FIG. 6 in the embodiment.

An objective evidence that there are two pulses in the third technique (Patent Document 2) lies in that the number of pulses is two even when the number of cells which perform sustained discharge is zero because a waveform is intentionally fallen by CD-ON (t4 to tb). An interval of the two pulses becomes relatively long. On the other hand, an evidence of a single pulse (including t1 to t15) in the present embodiment lies in that, when the number of cells which perform sustained discharge is zero, a waveform becomes completely one pulse without voltage drop (t12).

In the present embodiment, a time of CU-OFF is normally 120 ns, and it is about 360 ns at maximum, which is relatively short. Besides, LU is turned ON at while CU is OFF. Therefore, voltage drop of discharge occurs but the waveform is not separated into two, thereby, operation where increasing intensity of discharge again after discharge is once attenuated moderately is realized.

As described above, according to the present embodiment, by controlling a sustain pulse whose discharge peak in a single driving waveform is separated into two, stable and efficient operation of sustained discharge can be ensured.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be utilized in a PDP device.

What is claimed is:

1. A driving method of a plasma display panel applying a driving voltage to at least two kinds of electrodes of a plasma display panel where at least two kinds of electrode groups are formed to perform discharge between said two kinds of electrodes,
wherein an operation of turning ON a switch element for controlling an operation for clamping said driving voltage to high voltage to start discharge is performed at least twice in generation of an arbitrary single waveform of said driving voltage.

2. The driving method of a plasma display panel according to claim 1,
wherein a field corresponding to a display area and a display period of said plasma display panel is for performing drive control of sustain operation in a sub-field obtained by temporally dividing the field into a plurality of pieces for gray scale expression, and
said single waveform of said driving voltage is a sustain pulse which is repeatedly applied to said two kinds of electrodes, while polarities thereof are alternately reversed, to generate sustained discharge between said two kinds of electrodes.

3. The driving method of a plasma display panel according to claim 1,
wherein, when said switch element for controlling operation of clamping said driving voltage to said high voltage to start discharge which is connected to a voltage power supply for said discharge is once turned OFF after a first ON,
a switch element for controlling an LC resonance operation in an energy recovery circuit is turned ON.

4. The driving method of a plasma display panel according to claim 1,
wherein a time period (w1) of a first ON state of said switch element for controlling operation of clamping the driving voltage to said high voltage to start discharge which is connected to said voltage power supply for said discharge is in a range of 40 ns or more to 200 ns or less.

5. The driving method of a plasma display panel according to claim 2,
wherein a time difference (w2) between a first ON and a second ON of said switch element for controlling operation of clamping said driving voltage to said high voltage to start discharge which is connected to a sustain voltage power supply for said sustained discharge is in a range of 100 ns or more to 400 ns or less.

6. The driving method of a plasma display panel according to claim 1,
wherein,
in rising of said single waveform of said driving voltage,
in an ON state of a first switch element for controlling the LC resonance operation in the energy recovery circuit, said driving voltage is raised up to a first voltage value (V1) smaller than said high voltage to start discharge according to said LC resonance operation,
next, in a relatively short ON state according to a first ON of a second switch element for controlling operation of clamping said driving voltage to said high voltage to start discharge, said driving voltage is raised up to about a sustain voltage (Vs) as said voltage of starting discharge,
next, in a short OFF state according to OFF of said second switch element, a first discharge peak is formed,
next, before discharge is converged, in a relatively long ON state according to second ON of said second switch element, said driving voltage is raised up to about said sustain voltage (Vs) as said high voltage to start discharge, and a second discharge peak is formed.

7. A plasma display device comprising a plasma display panel in which at least two kinds of electrode groups are formed, and a circuit section which drives and controls electrode groups of said plasma display panel, where a driving voltage is applied from said circuit portion to said two kinds of electrodes to perform discharge between said two kinds of electrodes,
wherein, in generation of an arbitrary single waveform of driving voltage in said circuit portion, an operation for turning ON a switch element for controlling operation of clamping said driving voltage to high voltage to start discharge is performed at least twice.

8. The plasma display device according to claim 7,
wherein a field corresponding to a display area and a display period of said plasma display panel is for performing drive control of sustain operation in a sub-field obtained by temporally dividing the field into a plurality of pieces for gray scale expression, and
said single waveform of said driving voltage is a sustain pulse which is repeatedly applied to said two kinds of electrodes, while polarities thereof are alternately reversed, to generate sustained discharge between said two kinds of electrodes.

9. The plasma display device according to claim 8,
wherein, in a circuit which generates said sustain pulse in said circuit section,
when said switch element for controlling operation of clamping said driving voltage to said high voltage to start discharge which is connected to a sustain voltage power supply for said sustained discharge, is once turned OFF after a first ON,
a switch element for controlling LC resonance operation in an energy recovery circuit is turned ON.

10. The plasma display device according to claim 7,
wherein, in rising of said single waveform of said driving voltage,
in an ON state of a first switch element for controlling LC resonance operation in said energy recovery circuit, said driving voltage is raised up to a first voltage value (V1) smaller than said high voltage to start discharge according to said LC resonance operation,
next, in a relatively short ON state according to a first ON of a second switch element for controlling operation of clamping said driving voltage to said high voltage to start discharge, said driving voltage is raised up to about a sustain voltage (Vs) as said high voltage to start discharge,
next, in a short OFF state according to OFF of said second switch element, a first discharge peak is formed,
next, before discharge is converged, in a relatively long ON state according to a second ON of said second switch element, said driving voltage is raised up to about said sustain voltage (Vs) as said high voltage to start discharge, and a second discharge peak is formed.
